(19) United States
(12) Patent Application Publication
(10) Pub. No.: US 2025/0104623 A1
(43) Pub. Date: Mar. 27, 2025

(54) PIXEL CIRCUIT, PIXEL DRIVING METHOD AND DISPLAY DEVICE

(71) Applicants: Chongqing BOE Display Technology Co., Ltd., Chongqing (CN); BOE TECHNOLOGY GROUP CO., LTD., Beijing (CN)

(72) Inventors: Xuebin Yuan, Beijing (CN); Yinglong Huang, Beijing (CN); Kai Zhang, Beijing (CN); Xinyu Wei, Beijing (CN)

(73) Assignees: Chongqing BOE Display Technology Co., Ltd., Chongqing (CN); BOE TECHNOLOGY GROUP CO., LTD., Beijing (CN)

(21) Appl. No.: 18/290,883

(22) PCT Filed: Mar. 27, 2023
(86) PCT No.: PCT/CN2023/084150

§ 371 Date: Jan. 22, 2024

(51) Int. Cl. G09G 3/3233

(52) U.S. Cl. CPC G09G 3/3233; G09G 2300/0852; G09G 2310/08; G09G 2320/0233; G09G 2330/021

(57) ABSTRACT

A pixel circuit includes a light-emitting element, a compensation control circuit, a data writing circuit, a driving circuit and a first energy storage circuit. The compensation control circuit writes a reference voltage into a control end of the driving circuit under the control of a first scanning signal. The data writing circuit writes a data voltage to the control end of the driving circuit under the control of a second scanning signal.

### TECHNICAL FIELD

The present disclosure relates to the field of display technology, in particular to a pixel circuit, a pixel driving method and a display device.

### BACKGROUND

In the related pixel circuit, when an oxide transistor is used, there occurs an issue of display abnormality due to insufficient threshold voltage compensation due to too low mobility of the oxide transistor.

### SUMMARY

In one aspect, embodiments of the present disclosure provide a pixel circuit including a light-emitting element, a compensation control circuit, a data writing circuit, a driving circuit, and a first energy storage circuit.

The compensation control circuit is electrically connected to a first scanning end, a reference voltage end, and a control end of the driving circuit, and is configured to write a reference voltage from the reference voltage end into the control end of the driving circuit under control of a first scanning signal from the first scanning end.

The data writing circuit is electrically connected to a second scanning end, a data line, and the control end of the driving circuit, and is configured to write a data voltage from the data line into the control end of the driving circuit under control of a second scanning signal from the second scanning end.

The first energy storage circuit is electrically connected to the control end of the driving circuit and is configured to store electric energy.

The driving circuit is configured to generate a current for driving the light-emitting element under control of a potential at the control end of the driving circuit.

Optionally, the effective turn-on duration of the first scanning end is longer than effective turn-on duration of the second scanning end.

Optionally, the pixel circuit according to at least one embodiment of the present disclosure further includes a first light-emission control circuit, a first initialization circuit and a second initialization circuit.

The first light-emission control circuit is electrically connected to a first light-emission control end, a first end of the driving circuit, and a first electrode of the light-emitting element, and is configured to control the first end of the driving circuit to be electrically connected to, or electrically disconnected from, the first electrode of the light-emitting element under control of a first light-emission control signal from the first light-emission control end; a second electrode of the light-emitting element is electrically connected to a first voltage end.

The first initialization circuit is electrically connected to a third scanning end, a first initial voltage end and the first end of the driving circuit, and is configured to write a first initial voltage from the first initial voltage end into the first end of the driving circuit under control of a third scanning signal from the third scanning end.

The second initialization circuit is electrically connected to the third scanning end, a second initial voltage end and the first electrode of the light-emitting element, and is configured to write a second initial voltage from the second initial voltage end into the first electrode of the light-emitting element under control of the third scanning signal.

Optionally, the pixel circuit of at least one embodiment of the present disclosure further includes a first initialization circuit.

A first end of the driving circuit is electrically connected to a first electrode of the light-emitting element.

The first initialization circuit is electrically connected to a third scanning end, a first initial voltage end and a first end of the driving circuit, and is configured to write a first initial voltage from the first initial voltage end into the first end of the driving circuit under control of a third scanning signal from the third scanning end.

Optionally, the pixel circuit of at least one embodiment of the present disclosure further includes a first light-emission control circuit and a first initialization circuit.

The first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under control of a first light-emission control signal from the first light-emission control end; a second electrode of the light-emitting element is electrically connected to a first voltage end.

The first initialization circuit is electrically connected to a third scanning end, a first initial voltage end and the first end of the driving circuit, and is configured to write a first initial voltage from the first initial voltage end into the first end of the driving circuit under control of a third scanning signal from the third scanning end.

Optionally, the pixel circuit according to at least one embodiment of the present disclosure further includes a first light-emission control circuit and a second initialization circuit.

The first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under control of a first light-emission control signal from the first light-emission control end; a second electrode of the light-emitting element is electrically connected to a first voltage end.

The second initialization circuit is electrically connected to the third scanning end, a second initial voltage end and the first electrode of the light-emitting element, and is configured to write a second initial voltage from the second initial voltage end into the first electrode of the light-emitting element under control of the third scanning signal.

Optionally, the effective turn-on duration of the first scanning end is longer than effective turn-on duration of the third scanning end.

Optionally, a first end of the first energy storage circuit is electrically connected to the control end of the driving circuit, and a second end of the first energy storage circuit is electrically connected to a first end of the driving circuit.

Optionally, the pixel circuit of at least one embodiment of the present disclosure further includes a second energy storage circuit.

A first end of the second energy storage circuit is electrically connected to the control end of the driving circuit, a second end of the second energy storage circuit is electrically connected to a second voltage end, and the second energy storage circuit is configured to store electric energy.

Optionally, the pixel circuit of at least one embodiment of the present disclosure further includes a second light-emission control circuit.

The second light-emission control circuit is electrically connected to a second light-emission control end, a power source voltage end and a second end of the driving circuit, and is configured to control the power source voltage end to be electrically connected to, or electrically disconnected from, the second end of the driving circuit under control of a second light-emission control signal from the second light-emission control end.

Optionally, the first light-emission control circuit includes a first transistor, the first initialization circuit includes a second transistor, and the second initialization circuit includes a third transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the second transistor is electrically connected to the third scanning end, a first electrode of the second transistor is electrically connected to the first initial voltage end, and a second electrode of the second transistor is electrically connected to the first end of the driving circuit.

A gate electrode of the third transistor is electrically connected to the third scanning end, a first electrode of the third transistor is electrically connected to the second initial voltage end, and a second electrode of the third transistor is electrically connected to the first electrode of the light-emitting element.

Optionally, the first initialization circuit includes a second transistor.

A gate electrode of the second transistor is electrically connected to the third scanning end, a first electrode of the second transistor is electrically connected to the first initial voltage end, and a second electrode of the second transistor is electrically connected to the first end of the driving circuit.

Optionally, the first light-emission control circuit includes a first transistor, and the first initialization circuit includes a second transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the second transistor is electrically connected to the third scanning end, a first electrode of the second transistor is electrically connected to the first initial voltage end, and a second electrode of the second transistor is electrically connected to the first end of the driving circuit.

Optionally, the first light-emission control circuit includes a first transistor, and the second initialization circuit includes a third transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the third transistor is electrically connected to the third scanning end, a first electrode of the third transistor is electrically connected to the second initial voltage end, and a second electrode of the third transistor is electrically connected to the first electrode of the light-emitting element.

Optionally, the compensation control circuit includes a fourth transistor, and the data writing circuit includes a fifth transistor.

A gate electrode of the fourth transistor is electrically connected to the first scanning end, a first electrode of the fourth transistor is electrically connected to the reference voltage end, and a second electrode of the fourth transistor is electrically connected to the control end of the driving circuit.

A gate electrode of the fifth transistor is electrically connected to the second scanning end, a first electrode of the fifth transistor is electrically connected to the data line, and a second electrode of the fifth transistor is electrically connected to the control end of the driving circuit.

Optionally, the driving circuit includes a driving transistor, and the second light-emission control circuit includes a sixth transistor.

A gate electrode of the sixth transistor is electrically connected to the second light-emission control end, a first electrode of the sixth transistor is electrically connected to the power source voltage end, and a second electrode of the sixth transistor is electrically connected to the second end of the driving circuit.

A gate electrode of the driving transistor is electrically connected to a control end of the driving circuit, a first electrode of the driving transistor is electrically connected to a first end of the driving circuit, and a second electrode of the driving transistor is electrically connected to the second end of the driving circuit.

Optionally, the first energy storage circuit includes a first capacitor and the second energy storage circuit includes a second capacitor.

A first end of the first capacitor is electrically connected to the control end of the driving circuit, and a second end of the first capacitor is electrically connected to the first end of the driving circuit.

A first end of the second capacitor is electrically connected to the control end of the driving circuit, and a second end of the second capacitor is electrically connected to the second voltage end.

In a second aspect, embodiments of the present disclosure provide a pixel driving method applied to the above-mentioned pixel circuit, with a display period including a compensation stage and a data writing stage independent from each other; the pixel driving method includes:
at the compensation stage, writing, by the compensation control circuit, a reference voltage from the reference voltage end into the control end of a driving circuit under control of a first scanning signal from the first scanning end;
at the data writing stage, writing, by the data writing circuit, a data voltage from the data line into the control end of the driving circuit under control of a second scanning signal from the second scanning end.

In a third aspect, embodiments of the present disclosure provide a display device including the pixel circuit as described above.

### BRIEF DESCRIPTION OF THE DRAWINGS

FIG. 1 is a schematic view showing a pixel circuit according to at least one embodiment of the present disclosure;

FIG. 2 is a schematic view showing a pixel circuit according to at least one embodiment of the present disclosure;

FIG. 3 is a schematic view showing a pixel circuit according to at least one embodiment of the present disclosure;

FIG. 4 is a schematic view showing a pixel circuit according to at least one embodiment of the present disclosure;

FIG. 5 is a schematic view showing a pixel circuit according to at least one embodiment of the present disclosure:

FIG. 6 is a schematic view showing a pixel circuit according to at least one embodiment of the present disclosure;

FIG. 7 is a schematic view showing a pixel circuit according to at least one embodiment of the present disclosure;

FIG. 8 is a schematic view showing a pixel circuit according to at least one embodiment of the present disclosure:

FIG. 9 is a schematic view showing a pixel circuit according to at least one embodiment of the present disclosure;

FIG. 10 is a circuit diagram of the pixel circuit according to at least one embodiment of the present disclosure;

FIG. 11 is a timing sequence diagram of at least one embodiment of the pixel circuit in FIG. 10:

FIG. 12 is a simulated timing sequence diagram of at least one embodiment of the pixel circuit in FIG. 10:

FIG. 13 is a circuit diagram of the pixel circuit according to at least one embodiment of the present disclosure:

FIG. 14 is a circuit diagram of the pixel circuit according to at least one embodiment of the present disclosure:

FIG. 15 is a circuit diagram of the pixel circuit according to at least one embodiment of the present disclosure.

### DETAILED DESCRIPTION

The technical solutions in the embodiments of the present disclosure will be described hereinafter clearly and completely with reference to the drawings of the embodiments of the present disclosure. Apparently, the following embodiments merely relate to a part of, rather than all of, the embodiments of the present disclosure, and based on these embodiments, a person of ordinary skill in the art may, without any creative effort, obtain other embodiments, which also fall within the scope of the present disclosure.

In the embodiments of the present disclosure, each transistor maybe a thin film transistor (TFT), a field effect transistor (FET), or any other element having a same characteristic. In order to differentiate two electrodes of the transistor, apart from a gate electrode, from each other, one of the two electrodes may be called as a first electrode, and the other may be called as a second electrode.

In actual use, when the transistor is a TFT or FET, the first electrode may be a drain electrode and the second electrode may be a source electrode, or the first electrode may be a source electrode and the second electrode may be a drain electrode.

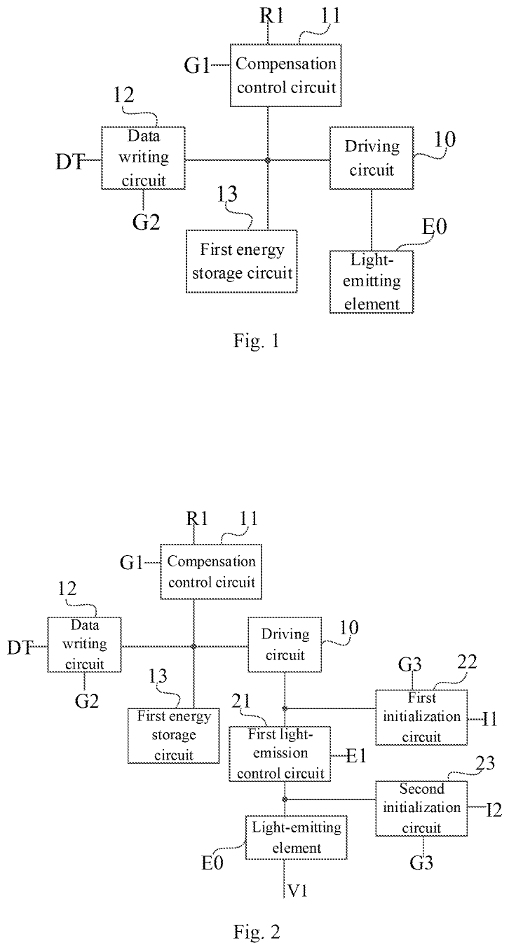

As shown in FIG. 1, a pixel circuit according to embodiments of the present disclosure includes a light-emitting element E0, a compensation control circuit 11, a data writing circuit 12, a driving circuit 10 and a first energy storage circuit 13.

The compensation control circuit 11 is electrically connected to a first scanning end G1, a reference voltage end R1 and a control end of the driving circuit 10, and is configured to write a reference voltage Vref from the reference voltage end R1 into the control end of the driving circuit 10 under control of a first scanning signal from the first scanning end G1.

The data writing circuit 12 is electrically connected to a second scanning end G2, a data line DT and the control end of the driving circuit 10 and is configured to write a data voltage Vdata from the data line DT into the control end of the driving circuit 10 under control of a second scanning signal from the second scanning end G2.

The first energy storage circuit 13 is electrically connected to the control end of the driving circuit 10 and is configured to store electric energy.

The driving circuit 10 is configured to generate a current for driving the light-emitting element E0 under control of a potential at the control end of the driving circuit.

In the pixel circuit shown in FIG. 1, the driving circuit 10 is electrically connected to the light-emitting element E0.

During the operation of the pixel circuit in FIG. 1 of the present disclosure, a display period includes a compensation stage and a data writing stage that are independent of each other.

At the compensation stage, the compensation control circuit 11 writes the reference voltage Vref from the reference voltage end R1 into the control end of the driving circuit 10 under the control of the first scanning signal from the first scanning end G1.

At the data writing stage, the data writing circuit 12 writes the data voltage Vdata from the data line DT into the control end of the driving circuit 10 under the control of the second scanning signal from the second scanning end G2.

In the embodiment of the present disclosure, a data writing path is separated from a compensation path, compensation time can be prolonged, so as to ensure that a better threshold voltage compensation effect can also be achieved when the pixel circuit uses an oxide transistor, thereby to address the issue of display abnormality caused by insufficient threshold voltage compensation due to too low mobility of an oxide transistor in the related art.

Optionally, the light-emitting element may be, but not limited to, an organic light emitting diode or a MiniLED (mini light emitting diode). In actual use, the light-emitting element may also be any other type of light-emitting diode.

In at least one embodiment of the present disclosure, effective turn-on duration of the first scanning end is longer than effective turn-on duration of the second scanning end. In this way, the threshold voltage compensation time is longer than the data writing time, so as to prolong the time for compensating the threshold voltage of the driving transistor in the driving circuit, thereby to sufficiently perform the threshold voltage compensation.

In at least one embodiment of the present disclosure, the effective turn-on duration of the second scanning end may refer to a time length during which the second scanning end continuously outputs an effective voltage signal.

The effective turn-on duration of the first scanning end may be a time length during which the first scanning end continues to output an effective voltage signal.

During the implementation, when a transistor controlled by the second scanning end is a p-type transistor, the effective voltage signal is a low voltage signal, and when the transistor controlled by the second scanning end is an n-type transistor, the effective voltage signal is a high voltage signal.

When a transistor controlled by the first scanning end is a p-type transistor, the effective voltage signal is a low voltage signal, and when the transistor controlled by the first scanning end is an n-type transistor, the effective voltage signal is a high voltage signal.

The pixel circuit according to at least one embodiment of the present disclosure further includes a first light-emission control circuit, a first initialization circuit and a second initialization circuit.

The first light-emission control circuit is electrically connected to a first light-emission control end, a first end of the driving circuit, and a first electrode of the light-emitting element, and is configured to control the first end of the driving circuit to be electrically connected to, or electrically disconnected from, the first electrode of the light-emitting element under control of a first light-emission control signal from the first light-emission control end. A second electrode of the light-emitting element is electrically connected to a first voltage end.

The first initialization circuit is electrically connected to a third scanning end, a first initial voltage end and the first end of the driving circuit, and is configured to write a first initial voltage from the first initial voltage end into the first end of the driving circuit under control of a third scanning signal from the third scanning end.

The second initialization circuit is electrically connected to the third scanning end, a second initial voltage end and the first electrode of the light-emitting element, and is configured to write a second initial voltage from the second initial voltage end into the first electrode of the light-emitting element under control of the third scanning signal.

During the implementation, the pixel circuit may further include a first light-emission control circuit, a first initialization circuit and a second initialization circuit, the first light-emission control circuit controls the first end of the driving circuit to be electrically connected to, or electrically disconnected from, the first electrode of the light-emitting element, the first initialization circuit is configured to initialize a potential at the first end of the driving circuit, and the second initialization circuit initializes a potential at the first electrode of the light-emitting element.

In at least one embodiment of the present disclosure, the first light-emission control circuit is provided. The first light-emission control circuit is arranged between the first end of a driving circuit and the first electrode of the light-emitting element, so that the compensation path is separated from the first electrode of the light-emitting element, thereby to prevent the display from being affected by the capacitance of the light-emitting element when threshold voltage compensation is performed.

In at least one embodiment of the present disclosure, the first initialization circuit and the second initialization circuit are provided. The first initialization circuit writes the first initial voltage into the first end of the driving circuit under the control of the third scanning signal, and the second initialization circuit writes the second initial voltage into the first electrode of the light-emitting element under the control of the third scanning signal, so as to separate the first initial voltage end from the second initial voltage end. The first initialization circuit provides a stable first initial voltage to the first end of the driving circuit. In addition, according to a voltage value of the first voltage signal at the first voltage end, a voltage value of the second initial voltage is dynamically adjusted, so as to save power consumption.

Optionally, the first voltage end may be a low voltage end for providing a low voltage signal.

In related display products, there are typically multiple DBVs (data brightness values, maximum display luminance values), i.e., different maximum brightness requirements. In a circuit aspect, various low voltage values (a low voltage value is a voltage value of a low voltage signal) are set. For example, when the display brightness is 1500 nits (nits), the low voltage value may be −8V. The second initial voltage is used to initialize the first electrode of the light-emitting element, and an optimal voltage value of the second initial voltage is related to the light-emitting element and the low voltage value. In the case where the light-emitting element is unchanged, in order to ensure the balance between the power consumption and a reset effect at the first electrode of the light-emitting element, a difference between the voltage value of the second initial voltage and the low voltage value is fixed (for example, the voltage value of the second initial voltage may be equal to the low voltage value, or the voltage value of the second initial voltage is less than the low voltage value), so that different low voltage values as well as different second initial voltages are required in case of different DBVs (in a case that the voltage value of the second initial voltage does not change with the low voltage value, the power consumption will be wasted). However, the first initial voltage is required for initializing the potential at the first end of the driving circuit, and in order to ensure that a voltage of the first end of the driving circuit is stable, the voltage value of the first initial voltage should not change. Therefore, in at least one embodiment of the present disclosure, the first light-emission control circuit and the second initialization circuit are used, so as to separate the first initial voltage end and the second initial voltage end.

As shown in FIG. 2, on the basis of the pixel circuit in FIG. 1, the pixel circuit according to at least one embodiment of the present disclosure further includes a first light-emission control circuit 21, a first initialization circuit 22 and a second initialization circuit 23.

The first light-emission control circuit 21 is electrically connected to a first light-emission control end E1, a first end of the driving circuit 10 and a first electrode of the light-emitting element E0, and is configured to control the first end of the driving circuit 10 to be electrically connected to, or electrically disconnected from, the first electrode of the light-emitting element E0 under the control of a first light-emission control signal from the first light-emission control end E1. A second electrode of the light-emitting element E0 is electrically connected to a first voltage end V1.

The first initialization circuit 22 is electrically connected to a third scanning end G3, the first initial voltage end I1 and the first end of the driving circuit 10, and is configured to write a first initial voltage Vinit1 from the first initial voltage end I1 into the first end of the driving circuit 10 under the control of a third scanning signal from the third scanning end G3.

The second initialization circuit 23 is electrically connected to the third scanning end G3, a second initial voltage end I2 and a first electrode of the light-emitting element E0, and is configured to write a second initial voltage Vinit2 from the second initial voltage end I2 into the first electrode of the light-emitting element E0 under the control of the third scanning signal.

In at least one embodiment of the present disclosure, the light-emitting element may be an organic light-emitting diode, the first electrode of the light-emitting element may be an anode, and the second electrode of the light-emitting element may be a cathode, which is not limited thereto.

Optionally, the first voltage end may be, but not limited to, a low voltage end or a ground end.

During the operation of the pixel circuit in FIG. 2, the display period includes an initialization stage prior to the compensation stage.

At the initialization stage, the compensation control circuit 11 writes the reference voltage Vref from the reference voltage end R1 into the control end of the driving circuit 10 under the control of the first scanning signal from the first scanning end G1, and the first initialization circuit 22 writes the first initial voltage Vinit1 from the first initial voltage end I1 into the first end of the driving circuit 10 under the control of the third scanning signal from the third scanning end G3, so that the driving circuit 10 can be turned on at the beginning of the compensation stage. Under the control of the third scanning signal, the second initialization circuit 2 writes the second initial voltage Vinit2 from the second initial voltage end I2 into the first electrode of the light-emitting element E0, so as to control the light-emitting element E0 not to emit light and clear residual charges at the first electrode of the light-emitting element E0.

At the initialization stage, the compensation stage and the data writing stage, the first light-emission control circuit 21 controls the first end of the driving circuit 10 to be electrically disconnected from the first electrode of the light-emitting element E0 under the control of the first light-emission control signal from the first light-emission control end E1.

In at least one embodiment of the present disclosure, the pixel circuit further includes a first initialization circuit.

A first end of the driving circuit is electrically connected to a first electrode of the light-emitting element.

The first initialization circuit is electrically connected to a third scanning end, a first initial voltage end and a first end of the driving circuit, and is configured to write a first initial voltage from the first initial voltage end into the first end of the driving circuit under control of a third scanning signal from the third scanning end.

During the implementation, the pixel circuit may further include the first initialization circuit, and the first end of the driving circuit is directly electrically connected to the first electrode of the light-emitting element, and the first initialization circuit may be used to initialize both the first end of the driving circuit and the first electrode of the light-emitting element.

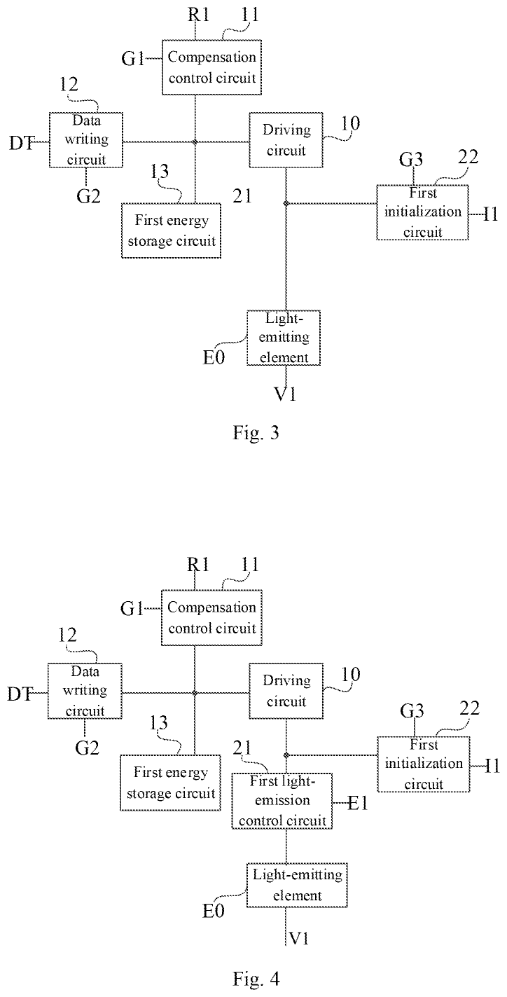

As shown in FIG. 3, on the basis of the pixel circuit in FIG. 1, the pixel circuit according to at least one embodiment of the present disclosure further includes a first initialization circuit 22.

A first end of the driving circuit 10 is electrically connected to a first electrode of the light-emitting element E0. A second electrode of the light-emitting element E0 is electrically connected to a first voltage end V1.

The first initialization circuit 22 is electrically connected to a third scanning end G3, a first initial voltage end I1 and a first end of the driving circuit 10, and is configured to write a first initial voltage Vinit1 from the first initial voltage end I1 into the first end of the driving circuit 10 under the control of a third scanning signal from the third scanning end G3.

During the operation of the pixel circuit in FIG. 3, the display period includes an initialization stage prior to the compensation stage.

At the initialization stage, the compensation control circuit 11 writes the reference voltage Vref from the reference voltage end R1 into the control end of the driving circuit 10 under the control of the first scanning signal from the first scanning end G1, and the first initialization circuit 22 writes the first initial voltage Vinit1 from the first initial voltage end I1 into the first end of the driving circuit 10 under the control of the third scanning signal from the third scanning end G3, so as to control the light-emitting element E0 not to emit light, clear residual charges at the first electrode of the light-emitting element E0 and enable the driving circuit 10 to be turned on at the beginning of the compensation stage.

In at least one embodiment of the present disclosure, the pixel circuit further includes a first light-emission control circuit and a first initialization circuit.

The first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under control of a first light-emission control signal from the first light-emission control end. A second electrode of the light-emitting element is electrically connected to a first voltage end.

The first initialization circuit is electrically connected to a third scanning end, a first initial voltage end and the first end of the driving circuit, and is configured to write a first initial voltage from the first initial voltage end into the first end of the driving circuit under the control of a third scanning signal from the third scanning end.

During the implementation, the pixel circuit may further include a first light-emission control circuit and a first initialization circuit, the first light-emission control circuit controls the first end of the driving circuit to be electrically connected to, or electrically disconnected from, the first electrode of the light-emitting element, the first initialization circuit controls the initialization of the potential at the first end of the driving circuit, and the first initialization circuit may initialize the potential at the first electrode of the light-emitting element when the first light-emission control circuit controls the first end of the driving circuit to be electrically connected to the first electrode of the light-emitting element.

As shown in FIG. 4, on the basis of the pixel circuit in FIG. 1, the pixel circuit according to at least one embodiment of the present disclosure further includes a first light-emission control circuit 21 and a first initialization circuit 22.

The first light-emission control circuit 21 is electrically connected to a first light-emission control end E1, a first end of the driving circuit 10 and a first electrode of the light-emitting element E0, and is configured to control the first end of the driving circuit 10 to be electrically connected to, or electrically disconnected from, the first electrode of the light-emitting element E0 under the control of a first light-emission control signal from the first light-emission control end E1. A second electrode of the light-emitting element E0 is electrically connected to a first voltage end V1.

The first initialization circuit 22 is electrically connected to a third scanning end G3, a first initial voltage end I1 and the first end of the driving circuit 10, and is configured to write a first initial voltage Vinit1 from the first initial voltage end I1 into the first end of the driving circuit 10 under the control of a third scanning signal from the third scanning end G3.

During the operation of the pixel circuit in FIG. 4, the display period includes an initialization stage prior to the compensation stage.

At the initialization stage, the first light-emission control circuit 21 controls the first end of the driving circuit 10 to be electrically connected to the first electrode of the light-emitting element E0 under the control of the first light-emission control signal, and the first initialization circuit 22 writes the first initial voltage Vinit1 from the first initial voltage end I1 into the first end of the driving circuit 10 under the control of the third scanning signal from the third scanning end G3, so as to initialize the potential at the first end of the driving circuit 10 and the potential at the first electrode of the light-emitting element E0. The compensation control circuit 11 writes the reference voltage Vref from the reference voltage end R1 into the control end of the driving circuit 10 under the control of the first scanning signal from the first scanning end G1, so as to control the light-emitting element E0 not to emit light, clear the residual charges at the first electrode of the light-emitting element E0, and enable the driving circuit 10 to be turned on at the beginning of the compensation stage.

The pixel circuit according to at least one embodiment of the present disclosure further includes a first light-emission control circuit and a second initialization circuit.

The first light-emission control circuit is electrically connected to a first light-emission control end, a first end of the driving circuit, and a first electrode of the light-emitting element, and is configured to control the first end of the driving circuit to be electrically connected to, or electrically disconnected from, the first electrode of the light-emitting element under control of a first light-emission control signal from the first light-emission control end. A second electrode of the light-emitting element is electrically connected to a first voltage end.

The second initialization circuit is electrically connected to the third scanning end, a second initial voltage end and the first electrode of the light-emitting element, and is configured to write a second initial voltage from the second initial voltage end into the first electrode of the light-emitting element under the control of the third scanning signal.

During the implementation, the pixel circuit may further include a first light-emission control circuit and a second initialization circuit, and the first light-emission control circuit may control the first end of the driving circuit to be electrically connected to, or electrically disconnected from, the first electrode of the light-emitting element under the control of the first light-emission control signal. The second initialization circuit initializes the potential at the first electrode of the light-emitting element under the control of the third scanning signal. When the first light-emission control circuit controls the first end of the driving circuit to be electrically connected to the first electrode of the light-emitting element, the second initialization circuit may initialize a potential at the first end of the driving circuit.

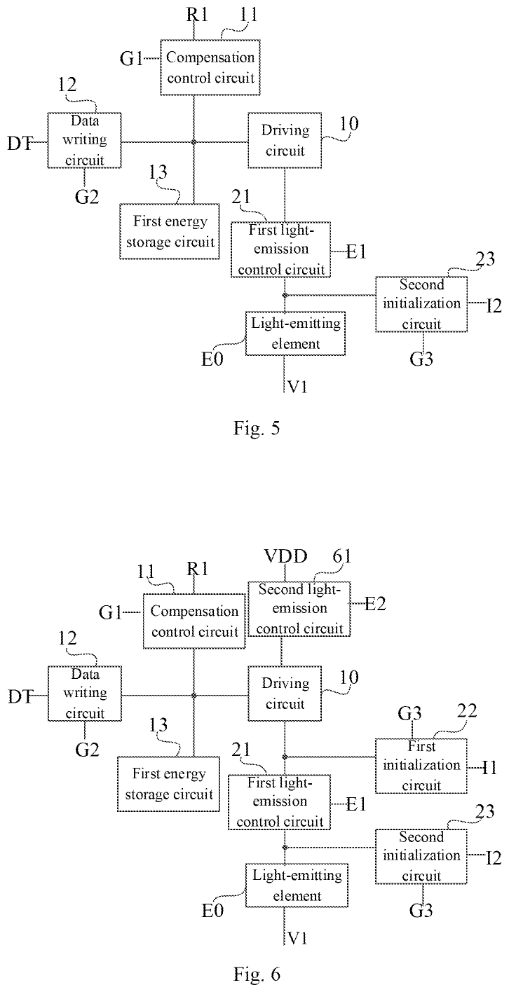

As shown in FIG. 5, on the basis of the pixel circuit in FIG. 1, the pixel circuit according to at least one embodiment of the present disclosure further includes a first light-emission control circuit 21 and a second initialization circuit 23.

The first light-emission control circuit 21 is electrically connected to a first light-emission control end E1, a first end of the driving circuit 10 and a first electrode of the light-emitting element E0, and is configured to control the first end of the driving circuit 10 to be electrically connected to, or electrically disconnected from, the first electrode of the light-emitting element E0 under the control of a first light-emission control signal from the first light-emission control end E1. A second electrode of the light-emitting element E0 is electrically connected to a first voltage end V1.

The second initialization circuit 23 is electrically connected to the third scanning end G3, a second initial voltage end I2 and a first electrode of the light-emitting element E0, and is configured to write a second initial voltage Vinit2 from the second initial voltage end I2 into the first electrode of the light-emitting element E0 under the control of the third scanning signal.

During the operation of the pixel circuit in FIG. 5, the display period includes an initialization stage prior to the compensation stage.

At the initialization stage, the first light-emission control circuit 21 controls the first end of the driving circuit 10 to be electrically connected to the first electrode of the light-emitting element E0 under the control of the first light-emission control signal, and the second initialization circuit 23 writes the second initial voltage Vinit2 from the second initial voltage end I2 into the first electrode of the light-emitting element E0 under the control of the third scanning signal, so as to initialize the potential at the first electrode of the light-emitting element E0 and the potential at the first end of the driving circuit 10. The compensation control circuit 11 writes the reference voltage Vref from the reference voltage end R1 into the control end of the driving circuit 10 under the control of the first scanning signal from the first scanning end G1, so as to control the light-emitting element E0 not to emit light, clear the residual charges at the first electrode of the light-emitting element E0, and enable the driving circuit 10 to be turned on at the beginning of the compensation stage.

In at least one embodiment of the present disclosure, effective turn-on duration of the first scanning end is greater than effective turn-on duration of the third scanning end.

During the implementation, the effective turn-on duration of the first scanning end is longer than the effective turn-on duration of the third scanning end, so that the threshold voltage compensation time is longer than the initialization time, thereby to realize sufficient threshold voltage compensation.

In at least one embodiment of the present disclosure, the effective turn-on duration of the third scanning end may refer to a time length during which the third scanning end continuously outputs an effective voltage signal.

During the implementation, when the transistor controlled by the first scanning end is a p-type transistor, the effective voltage signal is a low voltage signal, and when the transistor controlled by the first scanning end is an n-type transistor, the effective voltage signal is a high voltage signal.

When a transistor controlled by the third scanning end is a p-type transistor, the effective voltage signal is a low voltage signal, and when the transistor controlled by the third scanning end is an n-type transistor, the effective voltage signal is a high voltage signal.

Optionally, the first end of the first energy storage circuit is electrically connected to the control end of the driving circuit, and a second end of the first energy storage circuit is electrically connected to the a end of the driving circuit.

During the implementation, the first energy storage circuit may be disposed between the control end of the driving circuit and the first end of the driving circuit.

In at least one embodiment of the present disclosure, the pixel circuit further includes a second energy storage circuit.

A first end of the second energy storage circuit is electrically connected to the control end of the driving circuit, a second end of the second energy storage circuit is electrically connected to a second voltage end, and the second energy storage circuit is configured to store electric energy.

Optionally, the second voltage end may be, but is not limited to, a power source voltage end.

During the implementation, the pixel circuit in at least one embodiment of the present disclosure may further include a second energy storage circuit, the second energy storage circuit may be disposed between the control end of the driving circuit and the second voltage end, the second energy storage circuit may be used to regulate a range of the data voltage.

In at least one embodiment of the present disclosure, the pixel circuit further includes a second light-emission control circuit.

The second light-emission control circuit is electrically connected to a second light-emission control end, a power source voltage end and a second end of the driving circuit, and is configured to control the power source voltage end to be electrically connected to, or electrically disconnected from, the second end of the driving circuit under the control of a second light-emission control signal from the second light-emission control end.

In at least one embodiment of the present disclosure, the pixel circuit may include a second light-emission control circuit, and the second light-emission control circuit controls the power source voltage end to be electrically connected to, or electrically disconnected from, the second end of the driving circuit under the control of the second light-emission control signal. At the compensation stage and the light-emitting stage (the light-emitting stage may be arranged after the data writing stage), the second light-emission control circuit controls the power source voltage end to be electrically connected to the second end of the driving circuit under the control of the second light-emission control signal.

As shown in FIG. 6, on the basis of the pixel circuit in FIG. 2, the pixel circuit according to the at least one embodiment of the present disclosure further includes a second light-emission control circuit 61.

The second light-emission control circuit 61 is electrically connected to a second light-emission control end E2, a power source voltage end VDD and a second end of the driving circuit 10, and is configured to control the power source voltage end VDD to be electrically connected to, or electrically disconnected from, the second end of the driving circuit 10 under the control of the second light-emission control signal from the second light-emission control end E2.

During the operation of the pixel circuit in FIG. 6, the display period may include a light emitting stage after the data writing stage, and at the compensation stage and the light emitting stage, the second light-emission control circuit 61 controls the power source voltage end VDD to be electrically connected to the second end of the driving circuit 10 under the control of the second light-emission control signal.

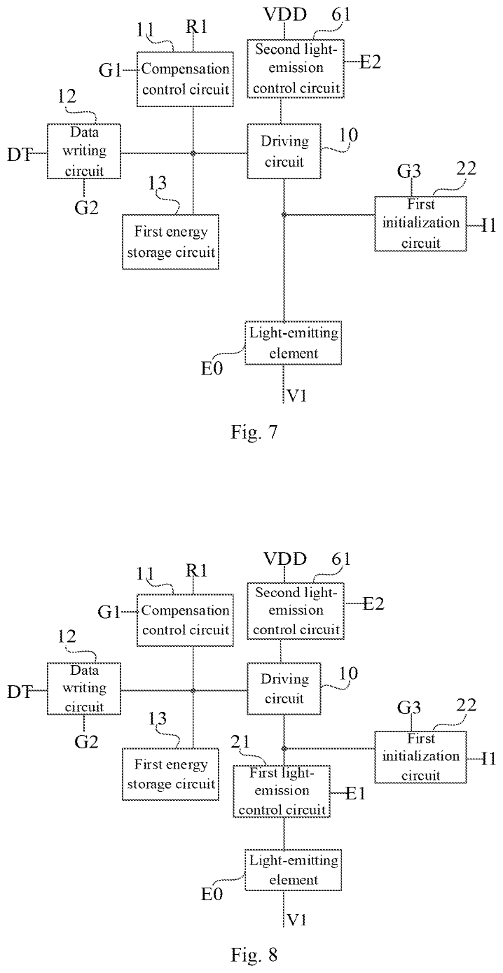

As shown in FIG. 7, on the basis of the pixel circuit in FIG. 3, the pixel circuit according to the at least one embodiment of the present disclosure further includes a second light-emission control circuit 61.

The second light-emission control circuit 61 is electrically connected to a second light-emission control end E2, a power source voltage end VDD and a second end of the driving circuit 10, and is configured to control the power source voltage end VDD to be electrically connected to, or electrically disconnected from, the second end of the driving circuit 10 under the control of a second light-emission control signal from the second light-emission control end E2.

During the operation of the pixel circuit in FIG. 7, the display period may include a light emitting stage after the data writing stage, and at the compensation stage and the light emitting stage, the second light-emission control circuit 61 controls the power source voltage end VDD to be electrically connected to the second end of the driving circuit 10 under the control of the second light-emission control signal.

As shown in FIG. 8, on the basis of the pixel circuit in FIG. 4, the pixel circuit according to the at least one embodiment of the present disclosure further includes a second light-emission control circuit 61.

The second light-emission control circuit 61 is electrically connected to a second light-emission control end E2, a power source voltage end VDD and a second end of the driving circuit 10, and is configured to control the power source voltage end VDD to be electrically connected to, or electrically disconnected from, the second end of the driving circuit 10 under the control of a second light-emission control signal from the second light-emission control end E2.

During the operation of the pixel circuit in FIG. 8, the display period may include a light emitting stage after the data writing stage, and at the compensation stage and the light emitting stage, the second light-emission control circuit 61 controls the power source voltage end VDD to be electrically connected to the second end of the driving circuit 10 under the control of the second light-emission control signal.

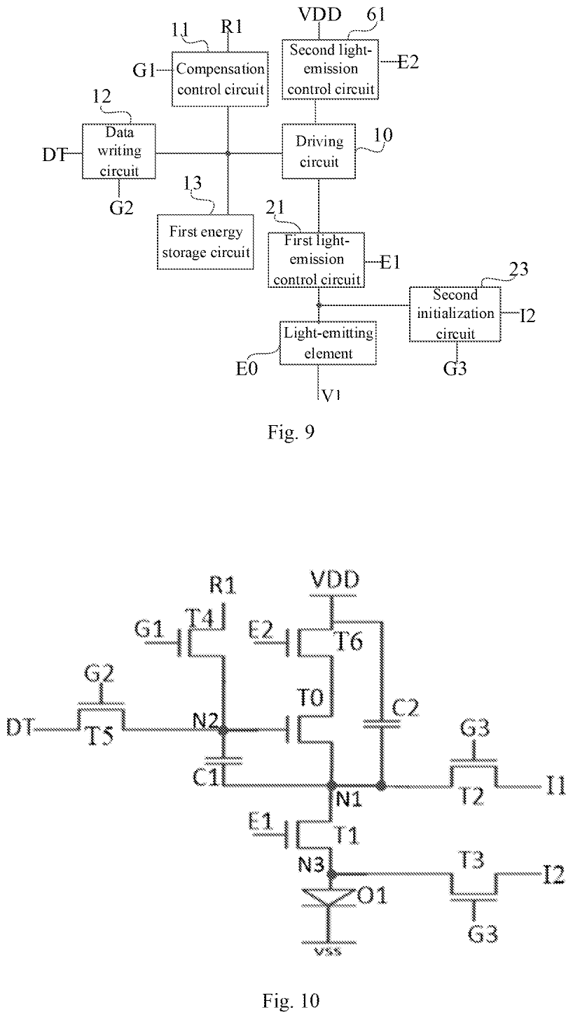

As shown in FIG. 9, on the basis of the pixel circuit in FIG. 5, the pixel circuit according to the at least one embodiment of the present disclosure further includes a second light-emission control circuit 61.

The second light-emission control circuit 61 is electrically connected to a second light-emission control end E2, a power source voltage end VDD and a second end of the driving circuit 10, and is configured to control the power source voltage end VDD to be electrically connected to, or electrically disconnected from, the second end of the driving circuit 10 under the control of a second light-emission control signal from the second light-emission control end E2.

During the operation of the pixel circuit in FIG. 9, the display period may include a light emitting stage after the data writing stage, and at the compensation stage and the light emitting stage, the second light-emission control circuit 61 controls the power source voltage end VDD to be electrically connected to the second end of the driving circuit 10 under the control of the second light-emission control signal.

Optionally, the first light-emission control circuit may include a first transistor, the first initialization circuit may include a second transistor, and the second initialization circuit may include a third transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the second transistor is electrically connected to the third scanning end, a first electrode of the second transistor is electrically connected to the first initial voltage end, and a second electrode of the second transistor is electrically connected to the first end of the driving circuit.

A gate electrode of the third transistor is electrically connected to the third scanning end, a first electrode of the third transistor is electrically connected to the second initial voltage end, and a second electrode of the third transistor is electrically connected to the first electrode of the light-emitting element.

Optionally, the compensation control circuit includes a fourth transistor, and the data writing circuit includes a fifth transistor.

A gate electrode of the fourth transistor is electrically connected to the first scanning end, a first electrode of the fourth transistor is electrically connected to the reference voltage end, and a second electrode of the fourth transistor is electrically connected to the control end of the driving circuit.

A gate electrode of the fifth transistor is electrically connected to the second scanning end, a first electrode of the fifth transistor is electrically connected to the data line, and a second electrode of the fifth transistor is electrically connected to the control end of the driving circuit.

Optionally, the driving circuit includes a driving transistor, and the second light-emission control circuit includes a sixth transistor.

A gate electrode of the sixth transistor is electrically connected to the second light-emission control end, a first electrode of the sixth transistor is electrically connected to the power source voltage end, and a second electrode of the sixth transistor is electrically connected to the second end of the driving circuit.

A gate electrode of the driving transistor is electrically connected to the control end of the driving circuit, a first electrode of the driving transistor is electrically connected to a first end of the driving circuit, and a second electrode of the driving transistor is electrically connected to the second end of the driving circuit.

Optionally, the first energy storage circuit includes a first capacitor and the second energy storage circuit includes a second capacitor.

A first end of the first capacitor is electrically connected to the control end of the driving circuit, and a second end of the first capacitor is electrically connected to the first end of the driving circuit.

A first end of the second capacitor is electrically connected to the control end of the driving circuit, and a second end of the second capacitor is electrically connected to the second voltage end.

As shown in FIG. 10, on the basis of the pixel circuit in FIG. 6, the first light-emission control circuit may include a first transistor T1, the first initialization circuit may include a second transistor T2, and the second initialization circuit may include a third transistor T3. The light-emitting element may be an organic light-emitting diode O1. The driving circuit includes a driving transistor T0.

A gate electrode of the first transistor T1 is electrically connected to the first light-emission control end E1, a source electrode of the first transistor T1 is electrically connected to a source electrode of the driving transistor T0, and a drain electrode of the first transistor T1 is electrically connected to an anode of the organic light-emitting diode O1.

A gate electrode of the second transistor T2 is electrically connected to the third scanning end G3, a source electrode of the second transistor T2 is electrically connected to the first initial voltage end I1, and a drain electrode of the second transistor T2 is electrically connected to the source electrode of the driving transistor T0.

A gate electrode of the third transistor T3 is electrically connected to the third scanning end G3, a source electrode of the third transistor T3 is electrically connected to the second initial voltage end I2, and a drain electrode of the third transistor T3 is electrically connected to the anode of the organic light-emitting diode O1.

The compensation control circuit includes a fourth transistor T4, and the data writing circuit includes a fifth transistor T5.

A gate electrode of the fourth transistor T4 is electrically connected to the first scanning end G1, a source electrode of the fourth transistor T4 is electrically connected to the reference voltage end R1, and a drain electrode of the fourth transistor T4 is electrically connected to a gate electrode of the driving transistor T0.

A gate electrode of the fifth transistor T5 is electrically connected to the second scanning end G2, a source electrode of the fifth transistor T5 is electrically connected to the data line DT, and a drain electrode of the fifth transistor T5 is electrically connected to the gate electrode of the driving transistor T0.

The second light-emission control circuit includes a sixth transistor T6.

A gate electrode of the sixth transistor T6 is electrically connected to the second light-emission control end E2, a source electrode of the sixth transistor T6 is electrically connected to the power source voltage end VDD, and a drain electrode of the sixth transistor T6 is electrically connected to a drain electrode of the driving transistor T0.

The first energy storage circuit includes a first capacitor C1, and the second energy storage circuit includes a second capacitor C2.

A first end of the first capacitor C1 is electrically connected to the gate electrode of the driving transistor T0, and a second end of the first capacitor C1 is electrically connected to the source electrode of the driving transistor T0.

A first end of the second capacitor C2 is electrically connected to the gate electrode of the driving transistor T0, and a second end of the second capacitor C2 is electrically connected to the power source voltage end VDD.

A cathode of the organic light-emitting diode O1 is electrically connected to a low voltage end VSS.

In at least one embodiment of the pixel circuit shown in FIG. 10, all transistors are, but not limited to, n-type transistors.

Optionally, the first initial voltage end I1 is configured to apply the first initial voltage Vinit1, the second initial voltage end I2 is configured to apply the second initial voltage Vinit2, and the reference voltage end R1 is configured to apply the reference voltage Vref. The voltage value of the Vinit1 may be 3V-5V less than the voltage value of the Vref. The voltage value of a low voltage signal from the low voltage end VSS may be greater than or equal to −10V and less than or equal to 4V. The voltage value of the Vinit2 may be, but not limited to, consistent with or slightly less than the voltage value of the Vinit2.

In at least one embodiment of the present disclosure, the voltage value of the Vref may be, but not limited to, greater than or equal to −1V and less than or equal to 3V, and the voltage value of the data voltage Vdata on the data line may be, but not limited to, greater than or equal to 0.5V and less than or equal to 7V.

As shown in FIG. 11, during the operation of the pixel circuit in FIG. 10, a display period includes an initialization stage t1, a compensation stage t2, a data writing stage t3 and a light emitting stage t4 arranged one after another.

At the initialization stage t1, G3 provides a high voltage signal, G1 provides a high voltage signal, G2 provides a low voltage signal, both E1 and E2 provide a low voltage signal, T2 and T3 are turned on. I1 provides the first initial voltage Vinit1 to the source electrode of T0, I2 provides the second initial voltage Vinit2 to the anode of O1, T5 is turned on. R1 provides the reference voltage Vref to the gate electrode of T0, so that at the beginning of the compensation stage t2, TO can be turned on, and O1 is controlled not to emit light, and charges remaining on the anode electrode of O1 are cleared.

At the compensation stage t2, G3 provides a low voltage signal, G1 provides a high voltage signal, G2 provides a low voltage signal, E1 provides a low voltage signal, E2 provides a high voltage signal, T4 is turned on, and T6 is turned on.

At the beginning of the compensation stage t2, TO is turned on, so as to charge C1 and C2, and when the source voltage of T0 is charged to Vref-Vth (Vth is a threshold voltage of T0), TO is turned off.

At the data writing stage t3, G3 and G1 provide a low voltage signal, G2 provides a high voltage signal, E2 provides a low voltage signal, E1 provides a low voltage signal, T5 is turned on, T6 is turned off, DT provides the data voltage Vdata to the gate electrode of T0, the gate voltage of T0 is pulled up to Vdata from Vref. A source voltage of T0 is coupled by C1, so that the source voltage of T0 rises to (Vdata−Vref)×(C1z/(C1z+C2z)), at this time, a gate-source voltage Vgs of T0 becomes Vdata−(Vref−Vth)−(Vdata−Vref)×(C1z/(C1z+C2z)), namely, becoming (C2z/(C1z+C2z))×(Vdata−Vref)+Vth.

At the light-emitting stage t4, all of G1, G2 and G3 provide a low voltage signal, all of E1 and E2 provide a high voltage signal, T6 and T1 are turned on. TO drives O1 to emit light, and the light-emitting current Id of O1 is K (Vgs−Vth)², so the light-emitting current Id of O1 is K ((C2z/(C1z+C2z))×(Vdata−Vref))², where K is a current coefficient of T0. It is derived from the formula of the light-emitting current that the light-emitting current Id of O1 is independent of the threshold voltage of the driving transistor T0. At least one embodiment of the pixel circuit can compensate for the threshold voltage of T0, so as to provide better display uniformity, especially for a large-size oxide display device, the effect of improving display uniformity is relatively obvious.

In at least one embodiment of the present disclosure, the second energy storage circuit functions to adjust a data voltage range.

As shown in FIG. 11, a time during which a potential of the first scanning signal from G1 is a continuous high voltage is longer than a time during which a potential of the second scanning signal from G2 is a continuous high voltage, and the time during which the potential of the first scanning signal from G1 is a continuous high voltage is longer than a time during which a potential of the third scanning signal from G3 is a continuous high voltage, so that the threshold voltage compensation time is longer than the data writing time, and the threshold voltage compensation time is longer than the initialization time, thereby to improve the threshold voltage compensation effect.

In FIG. 10, a first node N1 is electrically connected to the source electrode of T0, a second node N2 is electrically connected to the gate electrode of T0, and a third node N3 is electrically connected to the anode of O1.

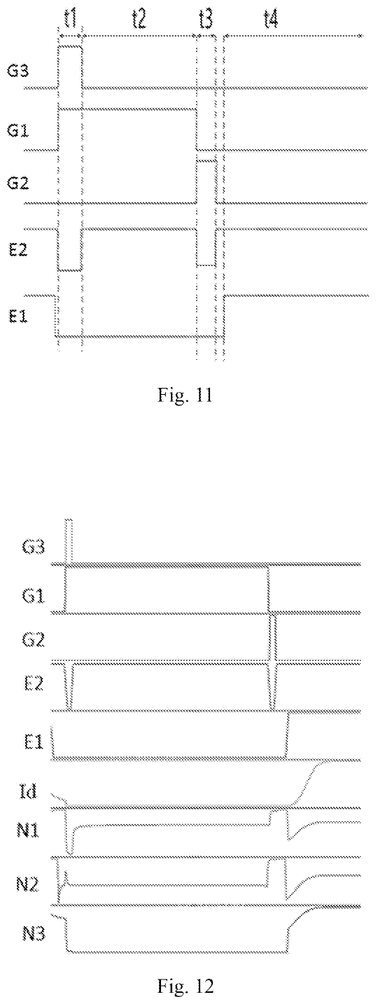

FIG. 12 is a simulated timing sequence diagram of at least one embodiment of the pixel circuit in FIG. 10.

Optionally, the first initialization circuit includes a second transistor.

A gate electrode of the second transistor is electrically connected to the third scanning end, a first electrode of the second transistor is electrically connected to the first initial voltage end, and a second electrode of the second transistor is electrically connected to the first end of the driving circuit.

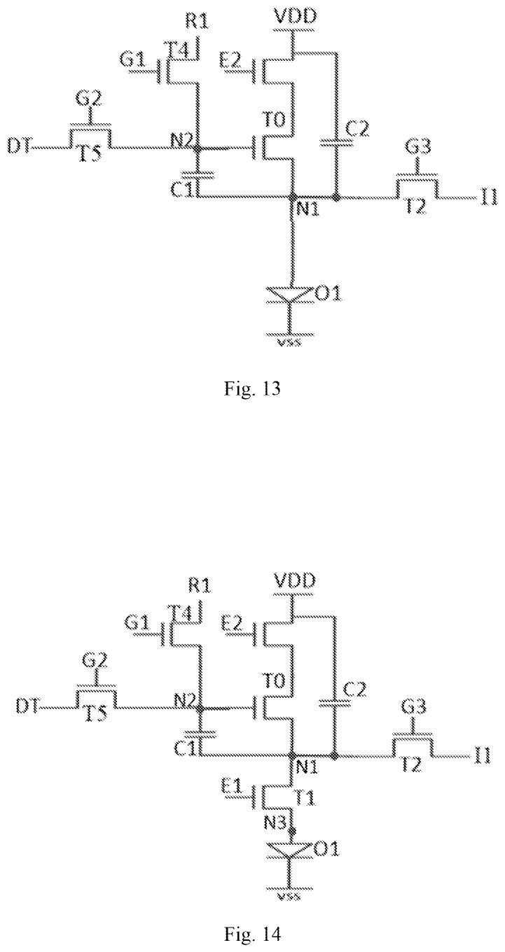

As shown in FIG. 13, on the basis of the pixel circuit in FIG. 7, the first initialization circuit may include a second transistor T2, and the light-emitting element may be an organic light-emitting diode O1. The driving circuit includes a driving transistor T0.

A gate electrode of the second transistor T2 is electrically connected to the third scanning end G3, a source electrode of the second transistor T2 is electrically connected to a first initial voltage end I1, and a drain electrode of the second transistor T2 is electrically connected to a source electrode of the driving transistor T0.

A source electrode of the driving transistor T0 is electrically connected to an anode electrode of the organic light-emitting diode O1.

The compensation control circuit includes a fourth transistor T4, and the data writing circuit includes a fifth transistor T5.

A gate electrode of the fourth transistor T4 is electrically connected to a first scanning end G1, a source electrode of the fourth transistor T4 is electrically connected to a reference voltage end R1, and a drain electrode of the fourth transistor T4 is electrically connected to a gate electrode of the driving transistor T0.

A gate electrode of the fifth transistor T5 is electrically connected to a second scanning end G2, a source electrode of the fifth transistor T5 is electrically connected to a data line DT, and a drain electrode of the fifth transistor T5 is electrically connected to the gate electrode of the driving transistor T0.

The second light-emission control circuit includes a sixth transistor T6.

A gate electrode of the sixth transistor T6 is electrically connected to the second light-emission control end E2, a source electrode of the sixth transistor T6 is electrically connected to a power source voltage end VDD, and a drain electrode of the sixth transistor T6 is electrically connected to a drain electrode of the driving transistor T0.

The first energy storage circuit includes a first capacitor C1, and the second energy storage circuit includes a second capacitor C2.

A first end of the first capacitor C1 is electrically connected to the gate electrode of the driving transistor T0, and a second end of the first capacitor C1 is electrically connected to the source electrode of the driving transistor T0.

A first end of the second capacitor C2 is electrically connected to the gate electrode of the driving transistor T0, and a second end of the second capacitor C2 is electrically connected to the power source voltage end VDD.

The cathode of the organic light-emitting diode O1 is electrically connected to a low voltage end VSS.

In at least one embodiment of the pixel circuit shown in FIG. 13, all transistors are, but not limited to, n-type transistors.

In at least one embodiment of the pixel circuit shown in FIG. 13, the first transistor and the third transistor are not provided, and both the source electrode of T0 and the anode of O1 are initialized by the second transistor.

Optionally, the first light-emission control circuit includes a first transistor, and the first initialization circuit includes a second transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the second transistor is electrically connected to the third scanning end, a first electrode of the second transistor is electrically connected to the first initial voltage end, and a second electrode of the second transistor is electrically connected to the first end of the driving circuit.

As shown in FIG. 14, on the basis of the pixel circuit in FIG. 8, the first light-emission control circuit includes a first transistor T1, and the first initialization circuit includes a second transistor T2. The driving circuit includes a driving transistor TO, and the light-emitting element is an organic light-emitting diode O1.

A gate electrode of the first transistor T1 is electrically connected to a first light-emission control end E1, a source electrode of the first transistor T1 is electrically connected to a source electrode of the driving transistor T0, and a drain electrode of the first transistor T1 is electrically connected to an anode of the organic light-emitting diode O1.

A gate electrode of the second transistor T2 is electrically connected to a third scanning end G3, a source electrode of the second transistor T2 is electrically connected to a first initial voltage end I1, and a drain electrode of the second transistor T2 is electrically connected to the source electrode of the driving transistor T0.

The compensation control circuit includes a fourth transistor T4, and the data writing circuit includes a fifth transistor T5.

A gate electrode of the fourth transistor T4 is electrically connected to a first scanning end G1, a source electrode of the fourth transistor T4 is electrically connected to a reference voltage end R1, and a drain electrode of the fourth transistor T4 is electrically connected to a gate electrode of the driving transistor T0.

A gate electrode of the fifth transistor T5 is electrically connected to a second scanning end G2, a source electrode of the fifth transistor T5 is electrically connected to a data line DT, and a drain electrode of the fifth transistor T5 is electrically connected to the gate electrode of the driving transistor T0.

The second light-emission control circuit includes a sixth transistor T6.

A gate electrode of the sixth transistor T6 is electrically connected to the second light-emission control end E2, a source electrode of the sixth transistor T6 is electrically connected to a power source voltage end VDD, and a drain electrode of the sixth transistor T6 is electrically connected to a drain electrode of the driving transistor TO.

The first energy storage circuit includes a first capacitor C1, and the second energy storage circuit includes a second capacitor C2.

A first end of the first capacitor C1 is electrically connected to the gate electrode of the driving transistor T0, and a second end of the first capacitor C1 is electrically connected to the source electrode of the driving transistor T0.

A first end of the second capacitor C2 is electrically connected to the gate electrode of the driving transistor T0, and a second end of the second capacitor C2 is electrically connected to the power source voltage end VDD.

The cathode of the organic light-emitting diode O1 is electrically connected to a low voltage end VSS.

In at least one embodiment of the pixel circuit shown in FIG. 14, all transistors are, but not limited to, n-type transistors.

In at least one embodiment of the pixel circuit shown in FIG. 14, the third transistor T3 is not provided, and the source electrode of T0 and the anode of O1 are initialized through the cooperation of T1 and T2.

Optionally, the first light-emission control circuit includes a first transistor, and the second initialization circuit includes a third transistor.

A gate electrode of the first transistor is electrically connected to the first light-emission control end, a first electrode of the first transistor is electrically connected to the first end of the driving circuit, and a second electrode of the first transistor is electrically connected to the first electrode of the light-emitting element.

A gate electrode of the third transistor is electrically connected to the third scanning end, a first electrode of the third transistor is electrically connected to the second initial voltage end, and a second electrode of the third transistor is electrically connected to the first electrode of the light-emitting element.

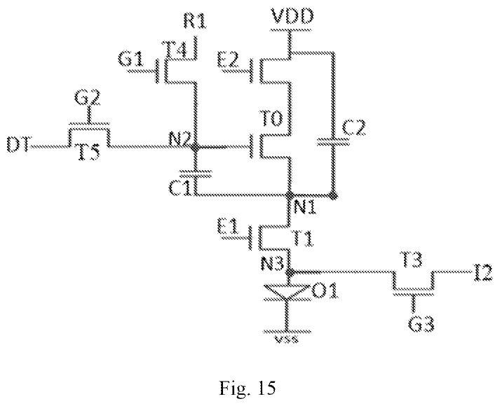

As shown in FIG. 15, on the basis of the pixel circuit in FIG. 9, the first light-emission control circuit includes a first transistor T1, and the second initialization circuit includes a third transistor T3. The driving circuit includes a driving transistor T0, and the light-emitting element is an organic light-emitting diode O1.

A gate electrode of the first transistor T1 is electrically connected to a first light-emission control end E1, a source electrode of the first transistor T1 is electrically connected to the first end of the driving circuit, and a drain electrode of the first transistor T1 is electrically connected to an anode of the organic light-emitting diode O1.

A gate electrode of the third transistor T3 is electrically connected to a third scanning end G3, a source electrode of the third transistor T3 is electrically connected to a second initial voltage end I2, and a drain electrode of the third transistor T3 is electrically connected to the anode of the organic light-emitting diode O1.

The compensation control circuit includes a fourth transistor T4, and the data writing circuit includes a fifth transistor T5.

A gate electrode of the fourth transistor T4 is electrically connected to a first scanning end G1, a source electrode of the fourth transistor T4 is electrically connected to a reference voltage end R1, and a drain electrode of the fourth transistor T4 is electrically connected to a gate electrode of the driving transistor T0.

A gate electrode of the fifth transistor T5 is electrically connected to a second scanning end G2, a source electrode of the fifth transistor T5 is electrically connected to a data line DT, and a drain electrode of the fifth transistor T5 is electrically connected to the gate electrode of the driving transistor T0.

The second light-emission control circuit includes a sixth transistor T6.

A gate electrode of the sixth transistor T6 is electrically connected to a second light-emission control end E2, a source electrode of the sixth transistor T6 is electrically connected to a power source voltage end VDD, and a drain electrode of the sixth transistor T6 is electrically connected to a drain electrode of the driving transistor TO.

The first energy storage circuit includes a first capacitor C1, and the second energy storage circuit includes a second capacitor C2.

A first end of the first capacitor C1 is electrically connected to the gate electrode of the driving transistor T0, and a second end of the first capacitor C1 is electrically connected to a source electrode of the driving transistor T0.

A first end of the second capacitor C2 is electrically connected to the gate electrode of the driving transistor T0, and a second end of the second capacitor C2 is electrically connected to the power source voltage end VDD.

The cathode of the organic light-emitting diode O1 is electrically connected to a low voltage end VSS.

In at least one embodiment of the pixel circuit shown in FIG. 15, all transistors are, but not limited to, n-type transistors.

In at least one embodiment of the pixel circuit shown in FIG. 15, the second transistor T2 is not provided, and the source electrode of T0 and the anode of O1 are initialized by the cooperation of T1 and T3.

The embodiments of the present disclosure further provides a pixel driving method, applied to the above-mentioned pixel circuit, the display period includes a compensation stage and a data writing stage which are independent from each other, and the pixel driving method includes:
at the compensation stage, writing, by the compensation control circuit, a reference voltage from the reference voltage end into the control end of the driving circuit under the control of a first scanning signal from the first scanning end,
at the data writing stage, writing, by the data writing circuit, a data voltage from the data line into the control end of the driving circuit under the control of a second scanning signal from the second scanning end.

In the embodiment of the present disclosure, the data writing stage is separated from the compensation stage, the compensation time can be prolonged, so as to ensure that a better threshold voltage compensation effect can also be achieved when the pixel circuit uses an oxide transistor, thereby to address the issue of display abnormality caused by insufficient threshold voltage compensation due to too low mobility of an oxide transistor in the related art.

The embodiments of the present disclosure further provides a display device including the above-described pixel circuit.

The above embodiments are preferred embodiments of the present disclosure, it should be appreciated that those skilled in the art may make various improvements and modifications without departing from the principle of the present disclosure, and theses improvement and modifications shall fall within the scope of the present disclosure.

1. A pixel circuit, comprising a light-emitting element, a compensation control circuit, a data writing circuit, a driving circuit, and a first energy storage circuit, wherein
the compensation control circuit is electrically connected to a first scanning end, a reference voltage end, and a control end of the driving circuit, and is configured to write a reference voltage from the reference voltage end into the control end of the driving circuit under control of a first scanning signal from the first scanning end;
the data writing circuit is electrically connected to a second scanning end, a data line, and the control end of the driving circuit, and is configured to write a data voltage from the data line into the control end of the driving circuit under control of a second scanning signal from the second scanning end;
the first energy storage circuit is electrically connected to the control end of the driving circuit and is configured to store electric energy; and
the driving circuit is configured to generate a current for driving the light-emitting element under control of a potential at the control end of the driving circuit.

2. The pixel circuit according to claim 1, wherein effective turn-on duration of the first scanning end is longer than effective turn-on duration of the second scanning end.

3. The pixel circuit according to claim 1, further comprising a first light-emission control circuit, a first initialization circuit and a second initialization circuit, wherein
the first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under control of a first light-emission control signal from the first light-emission control end; a second electrode of the light-emitting element is electrically connected to a first voltage end;
the first initialization circuit is electrically connected to a third scanning end, a first initial voltage end and the first end of the driving circuit, and is configured to write a first initial voltage from the first initial voltage end into the first end of the driving circuit under control of a third scanning signal from the third scanning end; and
the second initialization circuit is electrically connected to the third scanning end, a second initial voltage end and the first electrode of the light-emitting element, and is configured to write a second initial voltage from the second initial voltage end into the first electrode of the light-emitting element under control of the third scanning signal.

4. The pixel circuit according to claim 1, further comprising a first initialization circuit, wherein
a first end of the driving circuit is electrically connected to a first electrode of the light-emitting element; and
the first initialization circuit is electrically connected to a third scanning end, a first initial voltage end and a first end of the driving circuit, and is configured to write a first initial voltage from the first initial voltage end into the first end of the driving circuit under control of a third scanning signal from the third scanning end.

5. The pixel circuit according to claim 1, further comprising a first light-emission control circuit and a first initialization circuit, wherein
the first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under the control of a first light-emission control signal from the first light-emission control end; a second electrode of the light-emitting element is electrically connected to a first voltage end; and
the first initialization circuit is electrically connected to a third scanning end, a first initial voltage end and the first end of the driving circuit, and is configured to write a first initial voltage from the first initial voltage end into the first end of the driving circuit under control of a third scanning signal from the third scanning end.

6. The pixel circuit according to claim 1, further comprising a first light-emission control circuit and a second initialization circuit, wherein
the first light-emission control circuit is electrically connected to a first light-emission control end, a first end of the driving circuit and a first electrode of the light-emitting element, and is configured to control the first end of the driving circuit to be electrically connected to, or electrically disconnected from, the first electrode of the light-emitting element under control of a first light-emission control signal from the first light-emission control end; a second electrode of the light-emitting element is electrically connected to a first voltage end; and
the second initialization circuit is electrically connected to the third scanning end, a second initial voltage end and the first electrode of the light-emitting element, and is configured to write a second initial voltage from the second initial voltage end into the first electrode of the light-emitting element under the control of the third scanning signal.

7. The pixel circuit according to claim 3, wherein effective turn-on duration of the first scanning end is longer than effective turn-on duration of the third scanning end.

8. The pixel circuit according to claim 1, wherein a first end of the first energy storage circuit is electrically connected to the control end of the driving circuit, and a second end of the first energy storage circuit is electrically connected to a first end of the driving circuit.

9. The pixel circuit according to claim 8, further comprising a second energy storage circuit, wherein
a first end of the second energy storage circuit is electrically connected to the control end of the driving circuit, a second end of the second energy storage circuit is electrically connected to a second voltage end, and the second energy storage circuit is configured to store electric energy.

10. The pixel circuit according to claim 1, further comprising a second light-emission control circuit, wherein
the second light-emission control circuit is electrically connected to a second light-emission control end, a power source voltage end and a second end of the driving circuit, and is configured to control the power source voltage end to be electrically connected to, or electrically disconnected from, the second end of the driving circuit under control of a second light-emission control signal from the second light-emission control end.

11. The pixel circuit according to claim 3, wherein the first light-emission control circuit comprises a first transistor, the first initialization circuit comprises a second transistor, and the second initialization circuit comprises a third transistor;
a gate electrode of the first transistor is electrically connected to the first light-emission control end, a first electrode of the first transistor is electrically connected to the first end of the driving circuit, and a second electrode of the first transistor is electrically connected to the first electrode of the light-emitting element;
a gate electrode of the second transistor is electrically connected to the third scanning end, a first electrode of the second transistor is electrically connected to the first initial voltage end, and a second electrode of the second transistor is electrically connected to the first end of the driving circuit; and
a gate electrode of the third transistor is electrically connected to the third scanning end, a first electrode of the third transistor is electrically connected to the second initial voltage end, and a second electrode of the third transistor is electrically connected to the first electrode of the light-emitting element.

12. The pixel circuit according to claim 4, wherein the first initialization circuit comprises a second transistor; and
a gate electrode of the second transistor is electrically connected to the third scanning end, a first electrode of the second transistor is electrically connected to the first initial voltage end, and a second electrode of the second transistor is electrically connected to the first end of the driving circuit.

13. The pixel circuit according to claim 5, wherein the first light-emission control circuit comprises a first transistor, and the first initialization circuit comprises a second transistor:
a gate electrode of the first transistor is electrically connected to the first light-emission control end, a first electrode of the first transistor is electrically connected to the first end of the driving circuit, and a second electrode of the first transistor is electrically connected to the first electrode of the light-emitting element; and
a gate electrode of the second transistor is electrically connected to the third scanning end, a first electrode of the second transistor is electrically connected to the first initial voltage end, and a second electrode of the second transistor is electrically connected to the first end of the driving circuit.

14. The pixel circuit according to claim 6, wherein the first light-emission control circuit comprises a first transistor, and the second initialization circuit comprises a third transistor;
a gate electrode of the first transistor is electrically connected to the first light-emission control end, a first electrode of the first transistor is electrically connected to the first end of the driving circuit, and a second electrode of the first transistor is electrically connected to the first electrode of the light-emitting element; and
a gate electrode of the third transistor is electrically connected to the third scanning end, a first electrode of the third transistor is electrically connected to the second initial voltage end, and a second electrode of the third transistor is electrically connected to the first electrode of the light-emitting element.

15. The pixel circuit according to claim 10, wherein the compensation control circuit comprises a fourth transistor, and the data writing circuit comprises a fifth transistor;
a gate electrode of the fourth transistor is electrically connected to the first scanning end, a first electrode of the fourth transistor is electrically connected to the reference voltage end, and a second electrode of the fourth transistor is electrically connected to the control end of the driving circuit; and
a gate electrode of the fifth transistor is electrically connected to the second scanning end, a first electrode of the fifth transistor is electrically connected to the data line, and a second electrode of the fifth transistor is electrically connected to the control end of the driving circuit.

16. The pixel circuit according to claim 10, wherein the driving circuit comprises a driving transistor, and the second light-emission control circuit comprises a sixth transistor;
a gate electrode of the sixth transistor is electrically connected to the second light-emission control end, a first electrode of the sixth transistor is electrically connected to the power source voltage end, and a second electrode of the sixth transistor is electrically connected to the second end of the driving circuit; and
a gate electrode of the driving transistor is electrically connected to the control end of the driving circuit, a first electrode of the driving transistor is electrically connected to a first end of the driving circuit, and a second electrode of the driving transistor is electrically connected to the second end of the driving circuit.

17. The pixel circuit of claim 9, wherein the first energy storage circuit comprises a first capacitor, and the second energy storage circuit comprises a second capacitor;
a first end of the first capacitor is electrically connected to the control end of the driving circuit, and a second end of the first capacitor is electrically connected to the first end of the driving circuit; and
a first end of the second capacitor is electrically connected to the control end of the driving circuit, and a second end of the second capacitor is electrically connected to the second voltage end.

18. A pixel driving method, applied to the pixel circuit according to claim 1, with a display period comprising a compensation stage and a data writing stage independent of each other, wherein the pixel driving method comprises:
at the compensation stage, writing, by the compensation control circuit, a reference voltage from the reference voltage end into the control end of the driving circuit under the control of a first scanning signal from the first scanning end; and
at the data writing stage, writing, by the data writing circuit, a data voltage from the data line into the control end of the driving circuit under the control of a second scanning signal from the second scanning end.

19. A display device, comprising the pixel circuit according to claim 1.

20. The pixel circuit according to claim 4, wherein effective turn-on duration of the first scanning end is longer than effective turn-on duration of the third scanning end.
